(19) United States
(12) Patent Application Publication
(10) Pub. No.: US 2026/0030988 A1
(43) Pub. Date: Jan. 29, 2026

(54) SPACE-BASED MONITORING OF AIRCRAFT

(71) Applicant: The Boeing Company, Arlington, VA (US)

(72) Inventor: Arvel Alonzo Chappell, III, Las Vegas, NV (US)

(21) Appl. No.: 18/787,509

(22) Filed: Jul. 29, 2024

(51) Int. Cl. G08G 5/00; B64G 1/10

(52) U.S. Cl. CPC G08G 5/20; B64G 1/10; G08G 5/34

(57) ABSTRACT

Systems, apparatus, articles of manufacture, and methods are disclosed for space-based monitoring of aircraft. An example space-based apparatus to monitor aircraft includes communication interface circuitry to access aircraft operation data; machine-readable instructions; and programmable circuitry to be programmed by the machine-readable instructions to: identify an anomaly based on the aircraft operation data; prepare an updated mission plan for an aircraft based on the anomaly; and communicate the updated mission plan to the aircraft.

### FIELD OF THE DISCLOSURE

This disclosure relates generally to monitoring aircraft and, more particularly, to space-based monitoring of aircraft.

### BACKGROUND

Traditional monitoring of aircraft operation includes transmission of data from the aircraft to ground-based control systems. Transmission to ground-based control systems adds latency to decision-making processes. In addition, ground-based decision making processes are prone to human error.

### BRIEF DESCRIPTION OF THE DRAWINGS

FIG. 1 is a block diagram of an example environment in which an example space edge computer operates to monitor aircraft.

FIG. 2 is a block diagram of an example implementation of the space edge computer and aircraft of FIG. 1.

FIG. 3 is a flowchart representative of example machine-readable instructions and/or example operations that may be executed, instantiated, and/or performed by example programmable circuitry to implement the space edge computer of FIGS. 1 and 2.

FIG. 4 is a block diagram of an example processing platform including programmable circuitry structured to execute, instantiate, and/or perform the example machine-readable instructions and/or perform the example operations of FIG. 3 to implement the space edge computer of FIGS. 1 and 2.

In general, the same reference numbers will be used throughout the drawing(s) and accompanying written description to refer to the same or like parts.

The figures are not necessarily to scale.

### DETAILED DESCRIPTION

Spaced-based monitoring of aircraft is disclosed. An autonomous space-based aircraft telemetry system overcomes limitations of ground-reliant control systems. In the fast-paced aviation field, where aircraft travel at high speeds, delays in communication and subsequent human factors are undesirable. Examples disclosed herein overcome latency and human error issues by leveraging space-based general compute abilities with crosslinked satellites to form a space-based virtual computer also referred to as a space edge computer.

The space edge computer can employ artificial intelligence and machine learning. In some examples, the space-based systems disclosed herein utilize machine learning models networked via crosslinked satellites in low Earth orbit (LEO) to monitor real-time flight computer telemetry data. The space edge computer can be trained on decades of historical flight computer data, maintenance records, and operator health data. The space edge computer can detect anomalous flight conditions, paths, weather patterns, aircraft conditions, and operator conditions in real-time. In some examples, the space edge computer operates autonomously and can alert human operators, reroute air traffic, and/or promptly provide corrective actions for aircraft. In some examples, the space edge computer forms an autonomous safety system.

The space edge computer autonomously manages coordination with other computers in orbit and/or is formed of a plurality of orbiting computers, microprocessors, processor circuits, and/or programmable circuitry. In some examples, the space edge computer utilizes machine learning techniques without requiring ground intervention. In some examples, the space edge computer dynamically allocates and/or shapes communication beams based on traffic demands, system constraints, and theater resiliency, as identified by the system in real-time. Additionally, in some examples, the space edge computer incorporates features such as overdrive, beam shapeshifting, mission planning, and/or platform diagnostics for self-tests of satellite and/or aircraft assets.

In some examples, the mission planning is based on one or more factors including, weather, air traffic, data related to the functioning of the aircraft, and/or data related to the pilots. Pilots may become impaired due to fatigue, illness, and/or stress. In some examples, there are sensors in aircraft for real-time monitoring of pilot engagement. The space edge computer assesses aircraft operation data to detect anomalies. Based on the anomalies, the space edge computer alters, modifies, updates, and/or otherwise prepares a mission plan for the aircraft. The updated mission plan, prepared based on space-based monitoring of the aircraft, enhances safe operation of the aircraft. Also, in some examples, the space edge computer alters, modifies, updates, and/or otherwise prepares an aircraft service plan and/or a healthcare plan in addition to the mission plan or in concert with the mission plan.

As used herein “aircraft operation data” includes data related to the functioning of the aircraft, the actions and physiology of aircraft personnel, passengers, weather, and/or air traffic. Examples of aircraft operation data include, without limitation, one or more of:
data from a flight data recorder (FDR) (e.g., airspeed, altitude, vertical speed, heading, attitude (pitch, roll, and yaw), engine parameters (thrust, temperature, fuel flow, etc.), control surface positions (rudder, aileron, elevator), flight control inputs (from pilots), rate of climb, rate of descent, etc.);
cockpit data and biometric sensor data (e.g., audio recordings from cockpit microphones, communication between pilots and air traffic control (ATC), cockpit ambient sounds (e.g., engine noise, alarms), alarm status for all instruments, oxygen levels, carbon dioxide levels, temperature, pilots' heart rate (e.g., measured from a high speed infrared (IR) camera), pilot eye tracking data (e.g., measured from a high speed IR camera), pilot pupil dilation data (e.g., measured from high speed IR camera), electrooculographic (EOG) data, pilot electrodermal activity (EDA) tonic and phasic data (e.g., measured from EDA sensors embedded in pilot controls surfaces), pilot temperature (e.g., measured from a high speed IR camera), cockpit door open/closed status, data from onboard cameras, pilot brain function data (e.g., electroencephalographic (EEG) data, magnetic resonance imaging (MRI) data, functional MRI (fMRI) data, including data gathered from sensors in a headset, headband, helmet, glasses, goggles, etc.), pilot speech data and voice analysis (e.g., intonation, volume, word choice), pilots' cognitive states, pilots' emotional states, pilots' facial expressions, pilots' facial symmetry, a breathing pattern and/or rate of respiration, etc.);
aircraft communications addressing and reporting system (ACARS) data (e.g., position reports, flight plan updates, weather updates, maintenance messages, operational status reports, etc.);
automatic dependent surveillance-broadcast (ADS-B) data and/or automatic dependent surveillance-contract (ADS-C) data (e.g., aircraft identification, position (latitude, longitude, and altitude), velocity (ground speed, vertical rate), aircraft status information (e.g., emergency status), etc.);
engine health monitoring (EHM) data (e.g., engine performance metrics (temperatures, pressures, vibrations), fuel efficiency, diagnostic information (e.g., fault codes, maintenance alerts), engine vibration analysis, exhaust gas temperature (EGT) trends, oil pressure and temperature, fan speed and core speed, fuel flow rates and efficiency metrics, engine health indicators such as compressor and turbine performance, etc.);
passenger and cabin data (e.g., seat occupancy, in-flight entertainment usage, cabin temperature and pressure, lavatory usage, sound recordings, temperature, oxygen levels in the cabin, carbon dioxide levels in the cabin, smoke detection, number of passengers onboard, structural integrity data, stress and strain measurements on critical airframe components, fatigue monitoring of wings, fuselage, and tail sections, data on structural integrity from sensors embedded in the aircraft, etc.);
weather radar data (e.g., weather conditions ahead of the aircraft (e.g., precipitation, turbulence), wind shear detection, etc.);
traffic collision avoidance system (TCAS) data (e.g., nearby aircraft positions, collision alerts and resolution advisories, etc.);
navigation data (e.g., GPS coordinates, waypoint and route information, instrument landing system (ILS) data, planned destination, tail number, airline name, etc.);
satellite and communication systems data (e.g., satellite communication logs, data link communications with ground stations, etc.);
maintenance and diagnostic data (e.g., aircraft system statuses, fault detection and isolation, maintenance schedules and alerts, parts and build lots, part nonconformance reports and test anomalies, tire pressure and temperature, brake wear indicators, landing gear deployment and retraction cycle counts, shock absorber performance, hydraulic fluid levels and pressures, temperature of hydraulic fluids, leak detection, voltage and current levels in electrical circuits, battery status and performance, generator and alternator health, status of actuators and sensors for control surfaces (e.g., elevators, ailerons, rudders), fault detection in fly-by-wire systems, etc.); and/or
fuel management data (e.g., fuel consumption rates, fuel remaining, fuel efficiency metrics, etc.).

As used herein “anomaly” (or plural) includes a deviation from a standard, normal, traditional, and/or historical parameter. For example, an anomaly may be identified by calculating, comparing, and/or identifying a difference between a value of a measured parameter or metric with an average value based on historical and/or empirical data. The difference is compared to a threshold value. If the difference exceeds or otherwise satisfies the threshold value, an anomaly is detected or identified. In another example, an anomaly may be identified by calculating, comparing, and/or identifying a value of a measured parameter or metric with a threshold value based on historical and/or empirical data. If the value measured parameter or metric exceeds or otherwise satisfies the threshold value, an anomaly is detected or identified. In another example, an anomaly is detected or identified based on a detected word or series of words spoken by one or more aircraft personnel.

As used herein, “mission plan” includes a schedule and route of a flight path of an aircraft.

As used herein, “aircraft” includes machines that are capable of flight. Throughout this document, disclosure related to aircraft that operate within the Earth's atmosphere also applies to machines capable of flight in space, i.e., spacecraft.

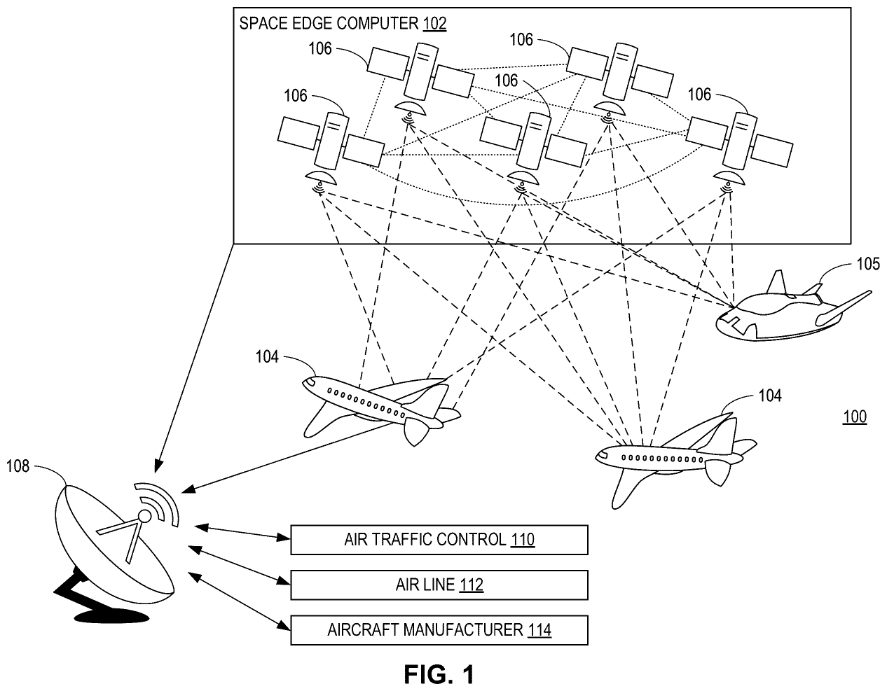

FIG. 1 is a block diagram of an example environment 100 in which an example space edge computer 102 operates to monitor aircraft 104 and/or spacecraft 105. As noted above, the term aircraft is understood to encompass spacecraft throughout this description and claims. The space edge computer 102 includes one or more microprocessors, processor circuits, and/or programmable circuitry on one or more satellites 106. In the example shown in FIG. 1, there are three satellites. In other examples, the space edge computer 102 is distributed over a different number of satellites such as one, two, four, ten, twenty, etc. The satellites 106 are located in space (i.e., space-based). In some examples, one or more of the satellites 106 are in low Earth orbit (LEO) (e.g., at an altitude of about 160 kilometers (km) to about 2,000 km). In some examples, one or more of the satellites 106 are in geosynchronous Earth orbit (GEO) (e.g., at an altitude of 35,786 km). Satellites orbiting in GEO have a period of rotation around the Earth precisely equal to one day. In some examples, one or more of the satellites 106 are in medium Earth orbit (MEO) (e.g., at an altitude of between LEO and GEO). In some examples, one or more of the satellites 106 are in the thermosphere. In some examples, one or more of the satellites 106 orbit above the Kármán line (i.e., 100 km above mean sea level). In some examples, one or more of the satellites 106 orbit at an altitude of at least 100 km. In some examples, satellites 106 are spread across different altitudes. In some examples, the satellites 106 are crosslinked.

The space edge computer 102 communicates with the aircraft 104 via communication systems and protocols. In some examples, communication occurs via radio frequencies. Example radio frequencies include UHF (300 to 1000 Megahertz, MHz), S (2 to 4 Gigahertz, GHz), X (8 to 12 GHZ), and/or Ka (27 to 40 GHz). In some example communication occurs via free space optical communications (i.e., lasercom), which uses optical wavelengths of electromagnetic radiation to transmit messages wirelessly. In some examples, communication use space communication protocol specifications (SCPS).

The space edge computer 102 and the aircraft 104 can also communicate with a ground-based communication service provider 108 or other gateway. Similar communication systems and protocols as disclosed above may be used for such communications. In addition, in some examples, the aircraft 104 communication via an aircraft communications addressing and reporting system (ACARS). Data, messages, information, etc. (including, for example, aircraft operation data, anomalies, and/or mission plans, services plans, and/or healthcare plans) transmitted between the airborne systems (i.e., the space edge computer 102 and/or the aircraft 104) and the ground-based communication service provider 108 can be relayed to one or more of air traffic control 110, an airline 112, and/or an aircraft manufacturer 114. In some examples the space edge computer 102 communicates with the aircraft 104 and implement example monitoring and mission planning systems disclosed herein without ground communications.

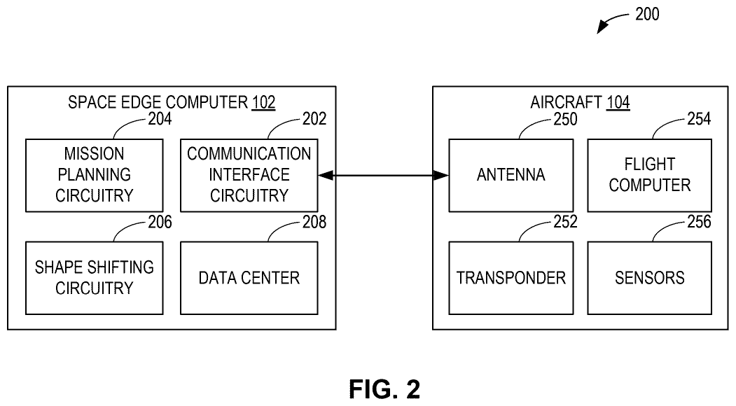

FIG. 2 is a block diagram of an example implementation of the space edge computer 102 and aircraft 104 of FIG. 1. The space edge computer 102 includes example communication interface circuitry 202, example mission planning circuitry 204, example shape shifting circuitry 206, and an example data center 208. The aircraft 104 includes an example antenna 250, an example transponder 252, an example flight computer 254, and example sensors 256.

The communication interface circuitry 202 receives, accepts, accesses, or otherwise obtains data that is analyzed by the space edge computer 102 to identify anomalies and improve and ensure safe operation of the aircraft 104. For example, the communication interface circuitry 202 receives historical data to be stored in the data center. The historical data can include any type of aircraft operation data used in calculating mission plans and modifications to mission plans in the past. In some examples, the communication interface circuitry 202 receives radar information related to weather. In some examples, the communication interface circuitry 202 receives aircraft operation data from the aircraft 104.

The aircraft 104 includes the flight computer 254 and sensors 256 that gather aircraft operation data including data disclosed above. As disclosed above, the aircraft operation data that can be gathered, compiled, calculated, etc. by the flight computer 254 and sensors 256 include a range of data including, for example, data related to position, orientation, fuel, speed, weather, functioning and maintenance of aircraft systems, TCAS, navigation, black box data, etc.

In some examples, as disclosed above, the sensors 256 gather biometric data such as biometric data from the pilots. The biometric data can be used to identify pilot impairment due to fatigue, illness, and/or stress. The sensors 256 conduct real-time monitoring of pilot engagement. In some examples, the sensors 256 include a multiband camera system that can identify and/or measure physiological responses such as, for example, pupil dilation, facial expressions, facial symmetry, heart rate, and/or pilot temperature. In some examples, the sensors 256 includes sensors with speech monitoring capability that can identify and/or detect slurred speech and/or stress. In some examples, the sensors 356 include non-invasive remote sensing hardware installed into cockpits of the airplane 104 to detect cognitive state of pilots. In some examples, the sensors 256 include one or more of cameras, infrared (IR) sensors, galvanic skin response (GSR) sensors, etc.

The aircraft 104 includes the transponder 252, which in some examples is compatible with ADS B/C. In some examples, the transponder 252 has two-way transmission with the flight computer 254 to obtain data from the flight computer 254. The transponder 252 also is in communication with the sensors 256 to obtain data gathered by the sensors 256. In some examples, the transponder 252 has a kilohertz (kHz) update rate. Also, in some examples, the transponder supports inflight internet connective services such as Connexion by Boeing.

The aircraft 104 includes the antenna 250. The antenna 250 is in two-way communication with the transponder 252. The antenna 250 also is ADS B/C compatible. The antenna 250 receives telemetry via the transponder 252 from the flight computer 254 and the sensors 256. The antenna 250 transmits the telemetry to the space edge computer 102. In some examples, the antenna 250 transmits the telemetry to the ground-based communication service provider 108. In some examples, the antenna 250 uses laser communications, though other communication systems and protocols may be used. In some examples, the antenna 250 transmits signals at a Gigabit rate.

In some examples, the antenna 250 transmits the telemetry to the ground-based communication service provider 108. For example, the transponder 252 and/or the flight computer 254 may prepare an operation and/or maintenance log based on the aircraft operation data. The operation and/or maintenance log may be communicated via the antenna 250 and the ground-based communication service provider 108 to the airline 112 and/or the aircraft manufacturer 114. In this example, the airline 112 and/or the aircraft manufacturer 114 may obtain operation and/or maintenance logs while the aircraft 104 is in flight without waiting for the transfer of such data (e.g., via a USB drive) once the aircraft 104 has landed.

As noted above, the communication interface 202 of the space edge computer 102 receives data mentioned herein. In examples in which the space edge computer 102 is distributed over multiple satellites 106, crosslink communication is used to share data among the satellites 106. The aircraft operation data can be stored in the data center 208.

The mission planning circuitry 204 analyzes the aircraft operation data. In some examples the mission planning circuitry 204 analyzes the aircraft operation data to identify an anomaly based on the aircraft operation data. For example, the mission planning circuitry 204 may identify anomalous flight conditions, anomalous flight paths, anomalous weather patterns, anomalous aircraft conditions, pilot impairment, etc. The mission planning circuitry 204 compares the aircraft operation data to nominal ranges, thresholds, and/or historical flight behavior models to identify the anomalies. In some examples, the mission planning circuitry 204 leverages machine learning and artificial intelligence based on historical and present data to adjust algorithms used to identify anomalies.

In the example of identification of pilot impairment, the mission planning circuitry 204 monitors the biometric data from the sensors 256 and compares the data against to nominal ranges, thresholds, and/or historical flight data. If and/or when the mission planning circuitry 204 identifies deviations from this data and/or these models (e.g., physiological and/or speech markers that fall outside nominal ranges), the mission planning circuitry 204 instantly relays an alert to the Pilot in Command (PIC) and First Officer. In some examples, the mission planning circuitry 204 identifies and/or detects slurred speech and/or stress through emotive conjugation and voice spectral analysis to provide or develop in-depth insight into the pilot's cognitive and emotional state. The mission planning circuitry 204 compares the cognitive and emotional state to nominal ranges, thresholds, and/or historical flight to identify is there is an anomaly (e.g., pilot impairment). Additionally, in some examples, these deviations and/or anomalies are logged in the flight computer 254 and transmitted to Air Traffic Control (ATC) via ADS-B/C satellite transponders, ensuring a comprehensive response to any potential safety threats. In some examples, the deviations and/or anomalies are communicated to the ground via a satellite link. Also, in some examples, if no network is present, data (including anomalies) can be stored on the flight computer 254 for download once on the aircraft 104 is on the ground.

The integration of real-time physiological and speech data with historical flight behavior models, coupled with the transmission of this data to ATC via ADS-B/C satellite transponders, enhances existing safety protocols and also introduces a proactive, data-driven safety measure for the aviation industry. Existing solutions are passive and rely on self-report from airline personnel. Current solutions rely on frequency of input into the flight computer 254 and requires reminders to be sent via a prompt to the airline personnel respond to messages.

In some examples, when the mission planning circuitry 204 identifies an anomaly, the mission planning circuitry 204 prepares a mission plan or a modified or updated mission plan for the aircraft 104 based on the anomaly. The mission plan is communicated to the aircraft 104 via the communication interface circuitry 202 and the antenna 250. The mission plan can include a re-routing of the aircraft 104, an alert to human operators in the air (e.g., the pilots) and/or on the ground (e.g., ATC), a list of one or more corrective actions for the pilots to maneuver or otherwise implement, etc. The aircraft operation data updates as the aircraft remains in flight. Thus, the aircraft 104 may receive one or more additional updates to the mission plan from the mission planning circuitry 204 based on renewed analysis of the updated aircraft operation data throughout the duration of the flight.

In some examples, the space edge computer 102 can communicate with human operators in the air, in space, and/or on the ground with voice. For example, the space edge computer 102 can leverage generative AI and large language modeling.

In some examples, the space edge computer 102 receives or accesses aircraft operation data from multiple aircraft 104. In such examples, the mission planning circuitry 204 assess the aircraft operation data from the multiple aircraft 104 and identifies anomalies for one or more of the aircraft 104 based on the aircraft operation data for that aircraft 104 itself and/or aircraft operation data for other aircraft 104 (e.g., nearby aircraft 104). Based on the aircraft operation for the multiple aircraft 104 and the one or more anomalies, the mission planning circuitry 204 may develop a mission plan for one or more of the aircraft 104 and cause communication of the mission plan to the respective aircraft 104. In other words, a mission plan for an aircraft 104 may be based on its own aircraft operation data (and potential anomalies) and/or based on the aircraft operation data (and potential anomalies) of other aircraft 104. For example, if a first aircraft 104 has an anomaly that mission planning circuitry 204 determines indicates that the first aircraft 104 should take priority in a specific flight path (e.g., toward an airport), the mission planning circuitry 204 may send an updated mission plan to a second aircraft 104 to clear the flight path for the first aircraft 104. In some examples, the mission planning circuitry 204 circuitry plans or develops mission plans for multiple aircraft 104 at least partially simultaneously.

In some examples, the mission planning circuitry 204 can implement an API package to provide software interfacing with the satellites 106. The API package can be used with self-testing, Internet of Things (IoT) devices, automatic configuration server (ACS) to manage networked devices, Array Calc for software simulations, trusted computing, traffic reports, and diagnostics. In some examples, the mission planning circuitry 204 can implement a cloud based service for satellite constellations for scheduling, control, diagnostics, traffic planning, IoT systems, and health checks. In some examples, the mission planning circuitry 204 leverages autonomous satellite operations using machine learning (including software upgrades, factory tests, and IoT self-tests).

Also, in some examples, the mission planning circuitry 204 analyzes the aircraft operation data to alter, modify, update, and/or otherwise prepare an aircraft service plan to direct aircraft maintenance and/or a healthcare plan to assist in treatment of aircraft personnel and/or passenger.

In some examples, a large number of aircraft 104 are monitored at the same time. In this example, the communications theatre in which the space edge computer 102 communicates with the large number of aircraft 104 can get very crowded and experience bandwidth limitations. The shape shifting circuitry 206 can autonomously and dynamically shift the shape of communication beams based on air traffic. Communication links may be temporarily closed in one area of the communication theatre to provide additional bandwidth in another area. The shape shifting circuitry 206 adjusts the communication links in real time based on the traffic demands and without intervention or other input from a ground-based entity.

FIG. 2 is a block diagram of an example implementation of the space edge computer 102 of FIG. 1 to identify anomalies based on aircraft operation data and create mission plans in response thereto. The space edge computer 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the space edge computer 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

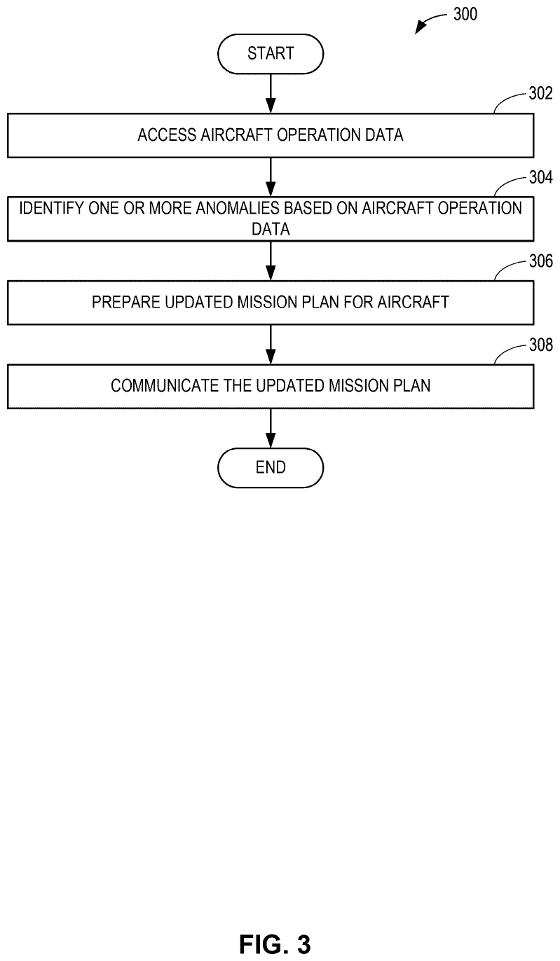

In some examples, the circuitry of FIGS. 1 and 2 is instantiated by programmable circuitry executing instructions and/or configured to perform operations such as those represented by the flowchart(s) of FIG. 3.

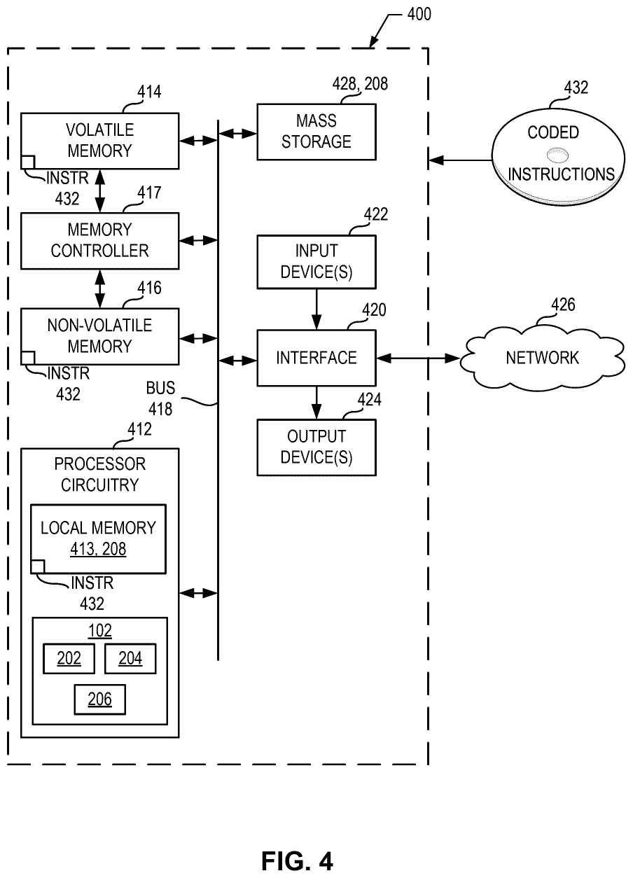

In some examples, the space edge computer 102 includes means for determining identifying anomalies based on aircraft operation data and/or means for preparing mission plans based on the anomalies. For example, the means for identifying and/or means for preparing may be implemented by mission planning circuitry 204. In some examples, the mission planning circuitry 204 may be instantiated by programmable circuitry such as the example programmable circuitry 412 of FIG. 4. For instance, the mission planning circuitry 204 may be instantiated by the example microprocessor 400 of FIG. 4 executing machine executable instructions such as those implemented by the blocks of FIG. 3. In some examples, the mission planning circuitry 204 may be instantiated by hardware logic circuitry, which may be implemented by an ASIC, XPU, or FPGA circuitry configured and/or structured to perform operations corresponding to the machine-readable instructions. Additionally or alternatively, the mission planning circuitry 204 may be instantiated by any other combination of hardware, software, and/or firmware. For example, the mission planning circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the space edge computer 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example communication interface circuitry 202, the example mission planning circuitry 204, the example shape shifting circuitry 206, the example data center 208, and/or, more generally, the example space edge computer 102 of FIG. 2, may be implemented by hardware alone or by hardware in combination with software and/or firmware. Thus, for example, any of the example communication interface circuitry 202, the example mission planning circuitry 204, the example shape shifting circuitry 206, the example data center 208, and/or, more generally, the example space edge computer 102, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example space edge computer 102 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine-readable instructions, which may be executed by programmable circuitry to implement and/or instantiate the space edge computer 102 of FIG. 2 and/or representative of example operations which may be performed by programmable circuitry to implement and/or instantiate the space edge computer 102 of FIG. 2, are shown in FIG. 3. The machine-readable instructions may be one or more executable programs or portion(s) of one or more executable programs for execution by programmable circuitry such as the programmable circuitry 412 shown in the example processor platform 400 discussed below in connection with FIG. 4 and/or may be one or more function(s) or portion(s) of functions to be performed by the example programmable circuitry (e.g., an FPGA). In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 3, many other methods of implementing the example space edge computer 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 3 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 3 is a flowchart representative of example machine-readable instructions and/or example operations 300 that may be executed, instantiated, and/or performed by programmable circuitry to identify anomalies based on aircraft operation data and prepare a mission plan in response thereto. The example machine-readable instructions and/or the example operations 300 of FIG. 3 include the communication interface circuitry 202 accessing aircraft operation data (block 302). The mission planning circuitry 204 identifies one or more anomalies based on the aircraft operation data (block 304). The mission planning circuitry 204 prepares an updated mission plan for the aircraft based on the anomalies (block 306). The mission planning circuitry 204 causes communication of and the communication interface circuitry 202 communicates the updated mission plan (block 308). For example, the updated mission plan is communicated to the aircraft 104 and/or to one or more ground-based entities. Thereafter, the example operations 300 end.

FIG. 4 is a block diagram of an example programmable circuitry platform 400 structured to execute and/or instantiate the example machine-readable instructions and/or the example operations of FIG. 3 to implement the space edge computer 102 of FIG. 2. The programmable circuitry platform 400 can be, for example, a server, a personal computer, a workstation, a self-learning machine (e.g., a neural network), a mobile device (e.g., a cell phone, a smart phone, a tablet such as an iPad™), an Internet appliance or other wearable device, or any other type of computing and/or electronic device.

The programmable circuitry platform 400 of the illustrated example includes programmable circuitry 412. The programmable circuitry 412 of the illustrated example is hardware. For example, the programmable circuitry 412 can be implemented by one or more integrated circuits, logic circuits, FPGAS, microprocessors, CPUs, GPUs, DSPs, and/or microcontrollers from any desired family or manufacturer. The programmable circuitry 412 may be implemented by one or more semiconductor based (e.g., silicon based) devices. In this example, the programmable circuitry 412 implements the space edge computer 102, the communication interface circuitry 202, the mission planning circuitry 204, and/or the shape shifting circuitry 206.

The programmable circuitry 412 of the illustrated example includes a local memory 413, 208 (e.g., a cache, registers, etc.). The programmable circuitry 412 of the illustrated example is in communication with main memory 414, 416, which includes a volatile memory 414 and a non-volatile memory 416, by a bus 418.

The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417. In some examples, the memory controller 417 may be implemented by one or more integrated circuits, logic circuits, microcontrollers from any desired family or manufacturer, or any other type of circuitry to manage the flow of data going to and from the main memory 414, 416.

The programmable circuitry platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 420. The input device(s) 422 permit(s) a user (e.g., a human user, a machine user, etc.) to enter data and/or commands into the programmable circuitry 412. The input device(s) 422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 400 of the illustrated example also includes one or more mass storage discs or devices 428, 208 to store firmware, software, and/or data. Examples of such mass storage discs or devices 428, 208 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 432, which may be implemented by the machine-readable instructions of FIG. 3, may be stored in the mass storage device 428, in the volatile memory 414, in the non-volatile memory 416, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that employ space-based monitoring of aircraft. Disclosed systems, apparatus, articles of manufacture, and methods improve the efficiency of using a computing device by enabling space-based analysis aircraft operation data and communication of modified mission plans to aircraft in-flight without the latency issues and human errors involved with communication to ground-based entities. Disclosed systems, apparatus, articles of manufacture, and methods are accordingly directed to one or more improvement(s) in the operation of a machine such as a computer or other electronic and/or mechanical device.

Examples disclosed herein use an autonomous satellite constellation network to monitor real-time flight computer telemetry data for monitoring safety of the aircraft and pilots. Disclosed examples detect anomalous flight conditions (e.g., low fuel, depressurization, flight recording data, operator fatigue/health concerns), weather patterns, aircraft conditions, and other aircraft operation data in real-time. By training space-based computer on decades of historical flight computer data, the system can autonomously alert human operators to provide corrective actions promptly, etc. By contrast, the existing satellite airplane monitoring techniques are simple relays meant for ATC with a high latency and low bandwidth (greater than a 3.2 min update rate). Real time monitoring and space-based autonomous alerts are not possible in existing systems. In addition, known aircraft telemetry system that ATC uses is either broadcast only (ADS-B) or at slow data rates (ADS-C) and cannot update fast enough for real-time tracking worldwide nor perform diagnostics or analytics on the aircraft operation data for passenger safety. In addition, traditional monitoring and telemetry systems do not provide product, operator, and/or passenger safety metrics directly.

Example systems, apparatus, articles of manufacture, and methods are disclosed for space-based monitoring of aircraft. Example 1 includes a space-based apparatus to monitor aircraft that includes communication interface circuitry to access aircraft operation data; machine-readable instructions; and programmable circuitry to be programmed by the machine-readable instructions to: identify an anomaly based on the aircraft operation data; prepare an updated mission plan for an aircraft based on the anomaly; and communicate the updated mission plan to the aircraft.

Example 2 includes the space-based apparatus of Example 1, wherein the programmable circuitry is to communicate one or more of the aircraft operation data, information related to the anomaly, or the updated mission plan to a ground-based entity.

Example 3 includes the space-based apparatus of Examples 1 or 2, wherein the programmable circuitry is to dynamically shift communication beams based on air traffic.

Example 4 includes the space-based apparatus of any of Examples 1-3, wherein the aircraft is a first aircraft, the aircraft operation data is first aircraft operation data, the anomaly is a first anomaly, and the updated mission plan is a first updated mission plan; the communication interface circuitry to access second aircraft operation data related to a second aircraft; and the programmable circuitry to: identify a second anomaly based on the second aircraft operation data; prepare a second updated mission plan for the second aircraft based on the second anomaly; and communicate the second updated mission plan to the second aircraft, wherein the programmable circuitry is to prepare the first updated mission plan and the second updated mission at least partially simultaneously.

Example 5 includes the space-based apparatus of any of Examples 1-4, wherein the aircraft is a first aircraft and the aircraft operation data is first aircraft operation data; the communication interface circuitry to access second aircraft operation data related to a second aircraft; and the programmable circuitry to identify the anomaly based on the second aircraft operation data.

Example 6 includes the space-based apparatus of any of Examples 1-5, wherein the programmable circuitry is to: prepare a maintenance log based on the aircraft operation data; and communicate the maintenance log to an aircraft manufacturer.

Example 7 includes the space-based apparatus of any of Examples 1-6, wherein the programmable circuitry is in the thermosphere.

Example 8 includes the space-based apparatus of any of Examples 1-7, wherein the communication interface circuitry and the programmable circuitry are at an altitude of at least 100 kilometers.

Example 9 includes the space-based apparatus of any of Examples 1-8, wherein the aircraft operation data includes pilot facial expressions and pilot voice analysis.

Example 10 includes the space-based apparatus of any of Examples 1-9, wherein the space-based apparatus is distributed over at least two satellites.

Example 11 includes a non-transitory machine-readable storage medium that includes instructions to cause at least one processor circuit positioned in space to at least: access aircraft operation data; identify an anomaly based on the aircraft operation data; prepare an updated mission plan for an aircraft based on the anomaly; and communicate the updated mission plan to the aircraft.

Example 12 include the machine-readable storage medium of Example 11, wherein the instructions cause at least one of the processor circuits to communicate one or more of the aircraft operation data, information related to the anomaly, or the updated mission plan to a ground-based entity.

Example 13 includes the machine-readable storage medium of Examples 11 or 12, wherein the aircraft is a first aircraft, the aircraft operation data is first aircraft operation data, the anomaly is a first anomaly, and the updated mission plan is a first updated mission plan; the instructions cause at least one of the processor circuits to: access second aircraft operation data related to a second aircraft; identify a second anomaly based on the second aircraft operation data; prepare a second updated mission plan for the second aircraft based on the second anomaly, the first updated mission plan and the second updated mission to be prepared at least partially simultaneously; and communicate the second updated mission plan to the second aircraft.

Example 14 includes the machine-readable storage medium of any of Examples 11-13, wherein the aircraft is a first aircraft and the aircraft operation data is first aircraft operation data; the instructions cause at least one of the processor circuits to: access second aircraft operation data related to a second aircraft; and identify the anomaly based on the second aircraft operation data.

Example 15 includes the machine-readable storage medium of any of Examples 11-14, wherein the storage medium and the at least one processor circuit are distributed over at least two satellites.

Example 16 includes the machine-readable storage medium of any of Examples 11-15, wherein the satellites are in low Earth orbit.

Example 17 includes a method of monitoring aircraft that includes identifying, by executing instructions with at least one processor circuit located in space, an anomaly based on aircraft operation data; preparing, by executing instructions with one or more of the processor circuits located in space, an updated mission plan for an aircraft based on the anomaly; and communicating the updated mission plan to the aircraft.

Example 18 includes the method of Example 17, wherein the aircraft is a first aircraft, the aircraft operation data is first aircraft operation data, the anomaly is a first anomaly, and the updated mission plan is a first updated mission plan, the method including: identifying, by executing instructions with one or more of the processor circuits located in space, a second anomaly based on second aircraft operation data; preparing, by executing instructions with one or more of the processor circuits located in space, a second updated mission plan for the second aircraft based on the second anomaly; and communicating the second updated mission plan to the second aircraft.

Example 19 includes the method of Examples 17 or 18, wherein the aircraft is a first aircraft and the aircraft operation data is first aircraft operation data, the method including identifying, by executing instructions with one or more of the processor circuits located in space, the anomaly based on second aircraft operation data.

Example 20 includes the method of any of Examples 17-19, wherein the one or more of the processor circuits are located on one or more satellites.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A space-based apparatus to monitor aircraft, the apparatus comprising:
communication interface circuitry to access aircraft operation data;
machine-readable instructions; and
programmable circuitry to be programmed by the machine-readable instructions to:
identify an anomaly based on the aircraft operation data;
prepare an updated mission plan for an aircraft based on the anomaly; and
communicate the updated mission plan to the aircraft.

2. The space-based apparatus of claim 1, wherein the programmable circuitry is to communicate one or more of the aircraft operation data, information related to the anomaly, or the updated mission plan to a ground-based entity.

3. The space-based apparatus of claim 1, wherein the programmable circuitry is to dynamically shift communication beams based on air traffic.

4. The space-based apparatus of claim 1, wherein the aircraft is a first aircraft, the aircraft operation data is first aircraft operation data, the anomaly is a first anomaly, and the updated mission plan is a first updated mission plan;
the communication interface circuitry to access second aircraft operation data related to a second aircraft; and
the programmable circuitry to:
identify a second anomaly based on the second aircraft operation data;
prepare a second updated mission plan for the second aircraft based on the second anomaly; and
communicate the second updated mission plan to the second aircraft, wherein the programmable circuitry is to prepare the first updated mission plan and the second updated mission at least partially simultaneously.

5. The space-based apparatus of claim 1, wherein the aircraft is a first aircraft and the aircraft operation data is first aircraft operation data;
the communication interface circuitry to access second aircraft operation data related to a second aircraft; and
the programmable circuitry to identify the anomaly based on the second aircraft operation data.

6. The space-based apparatus of claim 1, wherein the programmable circuitry is to:
prepare a maintenance log based on the aircraft operation data; and
communicate the maintenance log to an aircraft manufacturer.

7. The space-based apparatus of claim 1, wherein the programmable circuitry is in the thermosphere.

8. The space-based apparatus of claim 1, wherein the communication interface circuitry and the programmable circuitry are at an altitude of at least 100 kilometers.

9. The space-based apparatus of claim 1, wherein the aircraft operation data includes pilot facial expressions and pilot voice analysis.

10. The space-based apparatus of claim 1, wherein the space-based apparatus is distributed over at least two satellites.

11. A non-transitory machine-readable storage medium comprising instructions to cause at least one processor circuit positioned in space to at least:
access aircraft operation data;
identify an anomaly based on the aircraft operation data;
prepare an updated mission plan for an aircraft based on the anomaly; and
communicate the updated mission plan to the aircraft.

12. The machine-readable storage medium of claim 11, wherein the instructions cause at least one of the processor circuits to communicate one or more of the aircraft operation data, information related to the anomaly, or the updated mission plan to a ground-based entity.

13. The machine-readable storage medium of claim 11, wherein the aircraft is a first aircraft, the aircraft operation data is first aircraft operation data, the anomaly is a first anomaly, and the updated mission plan is a first updated mission plan;
the instructions cause at least one of the processor circuits to:
access second aircraft operation data related to a second aircraft;
identify a second anomaly based on the second aircraft operation data;
prepare a second updated mission plan for the second aircraft based on the second anomaly, the first updated mission plan and the second updated mission to be prepared at least partially simultaneously; and
communicate the second updated mission plan to the second aircraft.

14. The machine-readable storage medium of claim 11, wherein the aircraft is a first aircraft and the aircraft operation data is first aircraft operation data;
the instructions cause at least one of the processor circuits to:
access second aircraft operation data related to a second aircraft; and
identify the anomaly based on the second aircraft operation data.

15. The machine-readable storage medium of claim 11, wherein the storage medium and the at least one processor circuit are distributed over at least two satellites.

16. The machine-readable storage medium of claim 15, wherein the satellites are in low Earth orbit.

17. A method of monitoring aircraft, the method comprising:
identifying, by executing instructions with at least one processor circuit located in space, an anomaly based on aircraft operation data;
preparing, by executing instructions with one or more of the processor circuits located in space, an updated mission plan for an aircraft based on the anomaly; and
communicating the updated mission plan to the aircraft.

18. The method of claim 17, wherein the aircraft is a first aircraft, the aircraft operation data is first aircraft operation data, the anomaly is a first anomaly, and the updated mission plan is a first updated mission plan, the method including:
identifying, by executing instructions with one or more of the processor circuits located in space, a second anomaly based on second aircraft operation data;
preparing, by executing instructions with one or more of the processor circuits located in space, a second updated mission plan for the second aircraft based on the second anomaly; and
communicating the second updated mission plan to the second aircraft.

19. The method of claim 17, wherein the aircraft is a first aircraft and the aircraft operation data is first aircraft operation data, the method including identifying, by executing instructions with one or more of the processor circuits located in space, the anomaly based on second aircraft operation data.

20. The method of claim 17, wherein the one or more of the processor circuits are located on one or more satellites.
